(19) United States
(12) Patent Application Publication
(10) Pub. No.: US 2025/0178844 A1
(43) Pub. Date: Jun. 5, 2025

(54) APPARATUS AND METHOD FOR DIVIDING A CONTAINER MASS FLOW

(71) Applicant: KRONES AG, Neutraubling (DE)

(72) Inventors: Rico KINSKY, Regensburg (DE); Christian RICHTER, Aufhausen (DE); Stefan HEIGL, Obermotzing (DE)

(21) Appl. No.: 18/962,669

(22) Filed: Nov. 27, 2024

(30) Foreign Application Priority Data
Dec. 1, 2023 (DE) 10 2023 133 635.5

(51) Int. Cl. B65G 47/46

(52) U.S. Cl. CPC B65G 47/46

(57) ABSTRACT

An apparatus for dividing a container mass flow may include a container mass flow conveyor having a first container mass flow outlet and a second container mass flow outlet. The apparatus has a distribution device having a movable guide element for dividing the container mass flow to the first container mass flow outlet and the second container mass flow outlet and having a drive which is drivingly connected to the movable guide element in order to move the movable guide element. A detection device is configured to detect an occupancy level of the container mass flow conveyor upstream of the distribution device. A control device is configured to operate the drive in order to move the movable guide element to a desired position depending on the detected occupancy level.

### CROSS REFERENCE TO RELATED APPLICATIONS

This application claims the benefit under 35 U.S.C. § 119(a) of German Patent Application No. DE 10 2023 133 635.5, filed Dec. 1, 2023, entitled APPARATUS AND METHOD FOR DIVIDING A CONTAINER MASS FLOW, and whose entire disclosure is incorporated by reference herein.

### TECHNICAL FIELD

The invention relates to an apparatus for dividing a container mass flow for a container treatment system. The invention also relates to a method for dividing a container mass flow.

### TECHNICAL BACKGROUND

The distribution of a container mass flow over two machines or two inlets of a machine can be achieved, for example, by keeping the container conveyors in front of a distribution assembly relatively full. The container mass flow can then be divided over two outlets (or feeds to the two machines/two inlets) by a centrally arranged wedge of the distribution assembly.

From a control engineering point of view, it may be difficult or even impossible to keep these container conveyors full enough to ensure an even distribution over the two outlets. In these cases, one outlet can be backed up full first and, when it is completely filled, the second outlet can be filled with containers.

Another possibility is to use so-called press-in railings that press on the container mass flow using spring force. These are intended to guide the incoming container mass flow centrally to the dividing wedge and thus ensure a reasonably even distribution. However, the complex influencing factors in this case, such as container weight, conveyor chain selection, friction coefficient, etc., cannot be anywhere near taken into account by the spring force.

A disadvantage of the techniques described can be, for example, the high back pressures in the unevenly filled outlets. This can, for example, damage glass containers and create shards that can damage the container conveyor, etc. Plastics containers and cans, for example, can also be deformed. The containers can also become scratched. A further disadvantage may be reduced line efficiency due to time-consuming refilling with containers after downtime.

DE 92 04 040 U1 discloses a transport apparatus for upright vessels comprising a multi-track feed conveyor, a likewise multi-track discharge conveyor following in the conveying direction, and a transfer device connecting the feed conveyor to the discharge conveyor. The transfer device has a plurality of transfer portions, which each extend only over a part of the width of the feed and discharge conveyors and are arranged at an offset in the conveying direction. These transfer portions are preceded by guide means.

The invention is based on the object of creating an improved technique for dividing a container mass flow. Preferably, the technique should enable division with significantly reduced back pressures, as a result of which the containers and the system can be protected. Preferably, the technique should enable improved line efficiency.

### SUMMARY OF THE INVENTION

The object is achieved by the features of the independent claims. Advantageous developments are specified in the dependent claims and the description.

One aspect of the present disclosure relates to an apparatus for dividing a (e.g. ordered or disordered) container mass flow for a container treatment system. The apparatus comprises a (e.g. multi-track) container mass flow conveyor having a first container mass flow outlet and a second container mass flow outlet arranged (e.g. in parallel) next to the first container mass flow outlet. The apparatus has a distribution device having a movable, preferably pivotable, guide element for dividing the container mass flow to the first container mass flow outlet and the second container mass flow outlet (e.g. in a desired ratio) and having a drive which is drivingly connected to the movable guide element in order to move, preferably pivot, the movable guide element. The apparatus has a preferably contactless (e.g. optical) or tactile detection device which is configured to (e.g. directly or indirectly) detect a (current) occupancy level of the container mass flow conveyor upstream of the distribution device. The apparatus has a control device which is configured to operate the drive in order to move the movable guide element to a (particular) desired (e.g. pivoting and/or translation) position depending on the detected occupancy level, preferably selectively for even or uneven division of the container mass flow to the first container mass flow outlet and the second container mass flow outlet.

Advantageously, the apparatus can enable two outlets (feeds) to be filled in a desired ratio, e.g. even filling, by (intelligent) control of the distribution depending on the detected occupancy level. Advantageously, the occupancy level can already be detected/queried using the detection device before the distribution, and the subsequent distribution can be set to a desired position that distributes the incoming container mass flow in the desired ratio, e.g. evenly. Particularly advantageously, the apparatus can thus enable uniform, simultaneous filling of the two container mass flow outlets (feeds) and low back pressures.

Deformation and damage to the containers can be advantageously reduced. In addition, higher line efficiency can be achieved as a result of immediate restarting after a relatively long downtime. It is also possible to automatically redistribute an incoming container mass flow from one machine feed to another machine. This can be done during ongoing operation. This makes it possible to redirect the entire container flow to just a second machine if one machine fails. Other conceivable application options may include distribution as an automatic plug-in railing. This can be useful and practical as a special customer request, as circulation operation in the case of cleaning machines (relatively long system downtime in the case of glass bottles) or, for example, in the case of inaccessible heights.

In one embodiment, the drive has a self-locking gearing, preferably a worm gearing. Advantageously, the self-locking can prevent the movable guide element from being pushed away by a large container mass flow and thus enable a comparatively precise distribution of the container mass flow in the desired ratio. Furthermore, by using large reduction ratios, it may be possible to switch the adjustment with a relatively small application of force and also to carry out a switching process during production. This means that even if the occupancy level is currently very high and it is necessary to switch “into the container mass flow”, this is possible.

In a further embodiment, the movable guide element is mounted on a longitudinal outer side of the container mass flow conveyor such that said guide element is pivotable about a vertical axis for pivoting over a (e.g. horizontal) conveying face of the container mass flow conveyor. Advantageously, the movable guide element can thus be pivoted in and out into the particular desired position.

In a further embodiment, the movable guide element is mounted on a longitudinal outer side of the container mass flow conveyor for translation (e.g. retraction and extension) at an angle, preferably transversely, to a conveying direction or longitudinal axis of the container mass flow conveyor in order to move over a (e.g. horizontal) conveying face of the container mass flow conveyor. Advantageously, the movable guide element can thus be extended and retracted into the particular desired position.

In one embodiment, the movable guide element is in the form of a swivel arm. Alternatively or additionally, the movable guide element can be covered with a wall-shaped covering for guiding containers.

In a further embodiment, the detection device can be configured to (e.g. directly or indirectly) detect the occupancy level as the degree to which the container mass flow conveyor is occupied by containers transversely to its conveying direction or longitudinal axis, preferably:
(e.g. directly) as a number of transport tracks or transport elements of the container mass flow conveyor occupied by containers of the container mass flow or a value derived therefrom; and/or
(e.g. indirectly) by detecting a container-free transport width of the container mass flow conveyor or a value derived therefrom; and/or
starting from a longitudinal side of the container mass flow conveyor, preferably the longitudinal side on which the movable guide element is arranged, or the longitudinal side which is arranged opposite the movable guide element.

In a further embodiment, the detection device is configured to detect the occupancy level in a curved portion of the container mass flow conveyor, directly downstream of a curved portion of the container mass flow conveyor, at a lateral transfer of the container mass flow conveyor, or directly downstream of a lateral transfer of the container mass flow conveyor. Optionally, the curved portion or the lateral transfer can be configured and/or operable to stimulate the containers of the container mass flow to be applied to a longitudinal side of the container mass flow conveyor, preferably the longitudinal side on which the movable guide element is arranged. Advantageously, this makes it possible to ensure in a simple and reliable manner that the container mass flow reaching the distribution device is aligned or positioned towards a longitudinal outer side of the container mass flow conveyor.

In one embodiment, the detection device has a sensor bridge or a sensor bar, preferably having a plurality of spaced-apart sensors, which is arranged upstream of the distribution device and above the container mass flow conveyor, preferably above a curved portion of the container mass flow conveyor, above a lateral transfer of the container mass flow conveyor, above the container mass flow conveyor directly downstream of a curved portion or a lateral transfer of the container mass flow conveyor. This allows the occupancy level to be detected in a simple and reliable manner.

Alternatively or additionally, the detection device has, for example, a (e.g. contactless) distance sensor (e.g. light distance sensor, laser distance sensor or ultrasonic distance sensor), which is preferably arranged upstream of the distribution device and/or laterally next to the container mass flow conveyor, preferably aligned at a container conveying height of the container mass flow conveyor and/or transversely to a conveying direction of the container mass flow conveyor.

Alternatively or additionally, the detection device has, for example, a camera for detecting the occupancy level.

In one embodiment, the distribution device further comprises a wedge-shaped guide element which is arranged at a common upstream end of the first container mass flow outlet and of the second container mass flow outlet between the first container mass flow outlet and the second container mass flow outlet. Advantageously, this can further improve the division of the container mass flow over the two container mass flow outlets.

In one embodiment, the apparatus further comprises at least one further detection device which is configured to detect a container back-up (container jam) in or downstream of the first container mass flow outlet and/or in or downstream of the second container mass flow outlet. Preferably, the control device can be further configured to operate the drive in order to move the movable guide element to a desired position depending on the detected container back-up. Advantageously, distribution can thus be adapted by the apparatus to a back-up situation occurring downstream.

In a further embodiment, the apparatus further comprises a first container treatment device arranged downstream only from the first container mass flow outlet, and a second container treatment device arranged downstream only from the second container mass flow outlet. The control device can preferably be further configured to operate the drive in order to move the movable guide element to a desired position depending on an operating state of the first container treatment device and/or an operating state of the second container treatment device. Advantageously, distribution can thus be adapted by the apparatus to an operating state, e.g. a functional error that has occurred, in a container treatment device arranged downstream.

In one embodiment, the distribution device further comprises a container back-up protection element which is connected to the movable guide element for movement with the movable guide element in order to shield a (dead) space between a longitudinal outer side of the container mass flow conveyor and an inner side of the movable guide element facing the longitudinal outer side. This can advantageously prevent the mobility of the movable guide element from being impaired by backed-up containers.

In a further embodiment, the container back-up protection element is connected to a front end of the movable guide element, preferably in an articulated manner (e.g. so as to be pivotable). Alternatively or additionally, the container back-up protection element can be mounted on the longitudinal outer side so as to be pivotable about a vertical axis and/or translatable in parallel with the longitudinal outer side. Alternatively or additionally, the container back-up protection element can be covered with a wall-shaped covering for guiding containers. Alternatively or additionally, the container back-up protection element can be a, preferably translatable, swivel arm.

Another aspect of the present disclosure relates to a method for dividing a container mass flow preferably by an apparatus as disclosed herein (e.g. in a container treatment system). The method comprises the following:
by a preferably contactless (e.g. optical) or tactile detection device, detecting, upstream of a distribution device, an occupancy level of a (e.g. multi-track) container mass flow conveyor conveying a container mass flow; and
by a control device, operating a drive in order to move, preferably pivot, a movable, preferably pivotable, guide element of the distribution device to a (particular) desired (e.g. translation and/or pivoting) position depending on the detected occupancy level so as to divide the container mass flow to a first container mass flow outlet and a second container mass flow outlet of the container mass flow conveyor (e.g. in a desired ratio), selectively for even or uneven division of the container mass flow to the first container mass flow outlet and the second container mass flow outlet.

Advantageously, the method can achieve the same advantages as already described with reference to the apparatus.

In another embodiment, the method further comprises the following:
by at least one further detection device, detecting a container back-up in or downstream of the first container mass flow outlet and/or in or downstream of the second container mass flow outlet, wherein the operating of the drive by the control device in order to move the movable guide element to a desired position is also carried out depending on the detected container back-up.

Alternatively or additionally, the operating of the drive by the control device in order to move the movable guide element to a desired position can also be carried out depending on a (e.g. detected or received) operating state of a first container treatment device which is arranged downstream only from the first container mass flow outlet and depending on a (e.g. detected or received) operating state of a second container treatment device which is arranged downstream only from the second container mass flow outlet.

In another embodiment, the method further comprises the following:
by a container back-up protection element of the distribution device, preventing a back-up of containers into a (dead) space shielded by the container back-up protection element and located between a longitudinal outer side of the container mass flow conveyor and an inner side of the movable guide element facing the longitudinal outer side, wherein the container back-up protection element moves together with the movable guide element.

A further aspect of the present disclosure relates to a container treatment system (for example, for producing, cleaning, coating, inspecting, filling, closing, labeling, printing, and/or packaging containers for liquid media, preferably beverages or liquid foodstuffs). The container treatment system can comprise the apparatus as disclosed herein.

For example, the containers of the container mass flow can be bottles, cans, canisters, cartons, flacons, tubes, etc.

Preferably, the term “control device” can refer to an electronic system (e.g., embodied as a driver circuit or with microprocessor(s) and data memory) and/or a mechanical, pneumatic, and/or hydraulic controller, which can take over open-loop control tasks and/or closed-loop control tasks and/or processing tasks, depending on the configuration. Although the term “control” is used herein, this can also comprise or be understood as “closed-loop control” or “control with feedback” and/or “processing” as appropriate.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a schematic plan view of an apparatus for dividing a container mass flow according to an embodiment of the present disclosure;

FIG. 2 shows a perspective view of a distribution device of the exemplary apparatus; and

FIG. 3 shows a schematic plan view of a modified apparatus for dividing a container mass flow according to an embodiment of the present disclosure.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

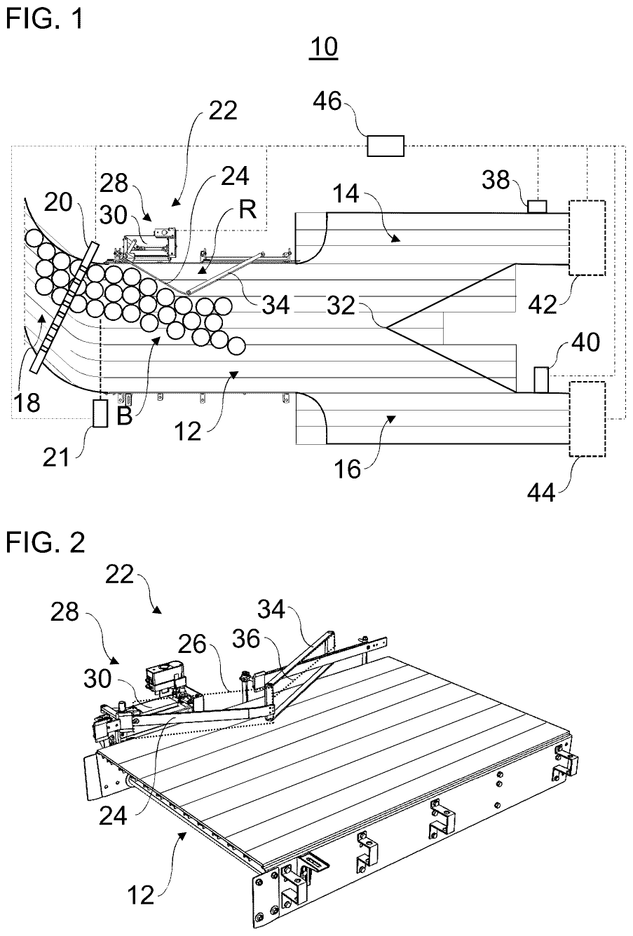

FIG. 1 shows an apparatus 10 for dividing a container mass flow B, and FIG. 2 shows a detail thereof. The container mass flow B to be divided can, for example, be ordered or disordered.

The apparatus 10 can be arranged or comprised in a container treatment system. The apparatus 10 can be arranged anywhere in a container treatment system where a container mass flow is to be divided into two container mass flows.

The apparatus 10 has a container mass flow conveyor 12, a detection device 20 and/or 21, a distribution device 22, and a control device 46. Optionally, the apparatus 10 can further comprise, for example, at least one further detection device 38, 40, a first container treatment device 42, and/or a second container treatment device 44.

The container mass flow conveyor 12 can transport the containers of the container mass flow B through a portion of the container treatment system. The container mass flow conveyor 12 can transport the containers of the container mass flow B in an upright position. The container mass flow conveyor 12 can be, for example, a mat chain conveyor, belt conveyor or plate conveyor or similar.

The container mass flow conveyor 12 can support the containers of the container mass flow B on the bottom side by a conveying face.

Preferably, the container mass flow conveyor 12 has multiple tracks. The container mass flow conveyor 12 can have a plurality of conveying tracks. The conveying tracks can run next to each other and together form the conveying face of the container mass flow conveyor 12. The tracks can, for example, each be formed by a circulating transport element, such as a belt or a mat chain. The conveying face can, for example, be formed by a plurality of transport elements arranged next to one another, such as belts or mat chains.

The container mass flow conveyor 12 has a first container mass flow outlet 14 and a second container mass flow outlet 16.

The first container mass flow outlet 14 is arranged next to the second container mass flow outlet 16. The first container mass flow outlet 14 and the second container mass flow outlet 16 can, for example, extend in parallel. The first container mass flow outlet 14 and the second container mass flow outlet 16 can receive, from a common container mass flow inlet of the container mass flow conveyor 12, the container mass flow B, divided by the distribution device 22.

The container mass flow conveyor 12 can have a curved portion 18. Otherwise, the container mass flow conveyor 12 can extend essentially in a straight line, e.g. in the region of the distribution device 22.

The curved portion 18 can be arranged on the input side with respect to the apparatus 10. The curved portion 18 can, for example, have the (common) container mass flow inlet. The curved portion 18 can be arranged upstream of the distribution device 22.

As shown in FIG. 1, the curved portion 18 can be configured and/or operable such that the containers of the container mass flow B are stimulated or acted upon to be applied to an inside of the curve of the curved portion 18. For example, the containers of the container mass flow B in the curved portion 18 can be stimulated or acted upon in such a way that, in addition to the movement in the conveying direction of the container mass flow conveyor 12, they also move in a direction transverse to the conveying direction or longitudinal axis towards the inside of the curve, for example until they each abut against the inside of the curve or against another container which is closer to the inside of the curve. Alternatively, the curved portion 18 can, for example, be configured and/or operable in such a way that the containers of the container mass flow B are stimulated or acted upon to be applied to an outside of the curve of the curved portion 18 (not shown in FIG. 1).

The detection device 20, 21 is configured to detect a (current) occupancy level of the container mass flow conveyor 12 upstream of the distribution device 22. The detection device 20, 21 can use any conceivable measuring principle to detect the occupancy level and can have any conceivable configuration and any conceivable arrangement.

Preferably, the detection device 20, 21 can detect the occupancy level as the degree to which the container mass flow conveyor 12 is occupied by containers of the container mass flow B transversely to a conveying direction or longitudinal axis of the container mass flow conveyor 12. Preferably, the occupancy level can be detected as a number of transport tracks or transport elements of the container mass flow conveyor 12 occupied by containers of the container mass flow B or a value derived therefrom (e.g. a length measurement or similar). Preferably, the occupancy level can be detected starting from a longitudinal side of the container mass flow conveyor 12, particularly preferably the longitudinal side on which a movable guide element 24 of the distribution device 22 is arranged.

In the illustrated embodiment of FIG. 1, the occupancy level can be detected by the detection device 20, 21 by way of example as four (out of eight) occupied transport tracks of the container mass flow conveyor 12.

Preferably, the detection device 20, 21 can detect the occupancy level in the curved portion 18 of the container mass flow conveyor 12, as shown by way of example in FIG. 1, or directly downstream of the curved portion 18.

Preferably, the detection device 20, 21 can be arranged upstream of the distribution device 22. Preferably, the detection device 20 can be arranged above a conveying face of the container mass flow conveyor 12. Preferably, the detection device 21 can be arranged next to a conveying face of the container mass flow conveyor 12.

As shown by way of example in FIG. 1, the detection device 20 can be, for example, a sensor bridge or a sensor bar. The sensor bridge or sensor bar can have a plurality of spaced-apart sensors. The number of sensors may depend on a width of the transport surface of the container mass flow conveyor 12.

For example, the detection device 20 may have between four and twenty sensors. Each sensor can, for example, be assigned to one or more of the transport tracks of the container mass flow conveyor 12 and detect the occupancy status of said one or more of the transport tracks. For example, over each transport track, at least one of the plurality of sensors can be arranged.

The sensor bridge or sensor bar can extend transversely to the conveying direction or longitudinal axis of the container mass flow conveyor 12 over the conveying face of the container mass flow conveyor 12, preferably over the curved portion 18.

Preferably, the detection device 20 can be a contactless detection device. The detection device 20 can, for example, have a plurality of optical or capacitive contactless distance sensors or contactless distance sensors based on another measuring principle. For example, above each transport track of the container mass flow conveyor 12, at least one distance sensor can be arranged.

Alternatively or in addition to the detection device 20, the detection device 21 can, for example, be arranged laterally on the container mass flow conveyor 12, e.g. at the transport height of the container mass flow B. The detection device 21 can, for example, detect, as a distance sensor, the distance to the containers of the container mass flow B in or after leaving the curved portion 18 and thus (indirectly) detect the occupancy level in the form of a distance measurement. The distance sensor can be, for example, a light sensor, an ultrasonic sensor, a laser sensor or another contactlessly measuring distance sensor. A camera could also be used as the detection device 21. In a camera recording, the occupancy level can then be determined by image analysis and then sent, for example, to the control device 46.

Alternatively or additionally, the detection device 20, 21 can be or have, for example, a tactile detection device. Containers of the container mass flow B moving through beneath the detection device 20 and/or containers of the container mass flow B moving past the detection device 21 can, for example, touch at least one sensor arm (e.g. of a plurality of movable, for example pivotable, sensor arms) and deflect it upwards or to the side, preferably pivot it. For example, above each transport track of the container mass flow conveyor 12, at least one sensor arm can be arranged.

The distribution device 22 divides the container mass flow B over the first container mass flow outlet 14 and the second container mass flow outlet 16.

The distribution device 22 comprises a guide element 24 and a drive 28. Optionally, the distribution device 22 may for example comprise another guide element 32 and/or a container back-up protection element 34.

The guide element 24 is movable. Preferably, the guide element 24 is pivotable. The guide element 24 can be moved, preferably pivoted, over a conveying face of the container mass flow conveyor 12. Depending on a position of the guide element 24, the container mass flow B is divided to the first container mass flow outlet 14 and to the second container mass flow outlet 16.

As shown by way of example in FIGS. 1 and 2, the guide element 24 can preferably be mounted on a longitudinal outer side of the container mass flow conveyor 12 such that said guide element is pivotable about a vertical axis for pivoting over the conveying face of the container mass flow conveyor 12. The guide element 24 can preferably be a swivel arm.

Alternatively or additionally, it is also possible, for example, for the movable guide element 24 to be mounted on a longitudinal outer side of the container mass flow conveyor 12 for translation at an angle, preferably transversely, to a conveying direction or longitudinal axis of the container mass flow conveyor 12 in order to move (translate) over the conveying face of the container mass flow conveyor 12.

The guide element 24 can be covered with a wall-shaped covering 26 for guiding containers of the container mass flow B. In this context, FIG. 2 shows, purely schematically, the covering 26, which is shown transparent. The covering 26 can, for example, be connected to the guide element 24 in a force-fitting and/or form-fitting manner.

The drive 28 is drivingly connected to the guide element 24 in order to move the guide element 24. The drive 28 can, for example, have an electric motor, a pneumatic motor or a hydraulic motor, etc. for driving the guide element 24.

Preferably, the drive 28 has a self-locking gearing 30. The self-locking gearing 30 can drivingly connect the motor to the guide element 24. The gearing 30 can, for example, be a worm gearing.

The guide element 32 can be wedge-shaped or tapered. The guide element 32 can be arranged at a common upstream end of the first container mass flow outlet 14 and of the second container mass flow outlet 16. The guide element 32 can be arranged in a stationary manner or be immovable. Containers of the container mass flow B impinging on the guide element 32 can be guided by the guide element 32 to the first container mass flow outlet 14 or to the second container mass flow outlet 16, depending on the impingement position.

The container back-up protection element 34 can shield or close a (dead) space R (see FIG. 1) between a longitudinal outer side of the container mass flow conveyor 12 and an inner side of the guide element 24 facing the longitudinal outer side. By the container back-up protection element 34 of the distribution device 22, a back-up of containers into the space R, which could block the guide element 24, can be prevented.

The container back-up protection element 34 can be connected to the guide element 24 for movement with the guide element 24. Preferably, the container back-up protection element 34 can be connected to a front end of the guide element 24, preferably in an articulated manner (e.g. so as to be pivotable about a vertical axis).

The container back-up protection element 34 can be mounted on the longitudinal outer side so as to be pivotable about a vertical axis and/or translatable in parallel with the longitudinal outer side. For example, a longitudinal guide can be arranged on the longitudinal outer side. The longitudinal guide can preferably extend in parallel with a conveying direction or longitudinal axis of the container mass flow conveyor 12. The container back-up protection element 34 can be translatably and pivotably mounted on the longitudinal guide, e.g. by a sliding piece or carriage with a pivot joint.

Preferably, the container back-up protection element 34 is a swivel arm that is translatable in parallel with the longitudinal outer side.

Similarly to the covering 26 for the guide element 24, the container back-up protection element 34 can be covered with a wall-shaped covering 36 for guiding containers of the container mass flow B (see purely schematically the transparently shown covering 36 in FIG. 2). The covering 26 can, for example, be connected to the container back-up protection element 34 in a force-fitting and/or form-fitting manner.

The further detection device 38, 40 can detect a container back-up in or downstream of the first container mass flow outlet 14 and/or in or downstream of the second container mass flow outlet 16.

For example, a first further detection device 38 can detect a container back-up in or downstream of the first container mass flow outlet 14. Preferably, the first further detection device 38 can be arranged in or downstream of the first container mass flow outlet 14.

Furthermore, a second further detection device 40 can detect a container back-up in or downstream of the second container mass flow outlet 16. Preferably, the second further detection device 40 can be arranged in or downstream of the second container mass flow outlet 16.

The at least one further detection device 38, 40 can be, for example, a tactile detection device. This can, for example, have a guide part which can be pressed in. The guide part can be arranged on a longitudinal outer side of the respective container mass flow outlet. The guide part can be able to be pressed in transversely to a conveying direction or longitudinal axis of the container mass flow conveyor 12. A container back-up can be detected if the guide part which can be pressed in is pressed in by the accumulating containers.

The first container treatment device 42 can be arranged downstream only from the first container mass flow outlet 14. The first container treatment device 42 can receive the containers of the container mass flow B distributed to the first container mass flow outlet 14 by the distribution device 22.

The second container treatment device 44 can be arranged downstream only from the second container mass flow outlet 16. The second container treatment device 44 can receive the containers of the container mass flow B distributed to the second container mass flow outlet 16 by the distribution device 22.

The container treatment devices 42, 44 can treat the containers in any conceivable way. For example, the container treatment devices 42, 44 can be configured as packaging devices for packaging containers.

However, it is also possible that a first inlet of a container treatment device is arranged downstream of the first container mass flow outlet 14 and a second inlet of the same container treatment device is arranged downstream of the second container mass flow outlet 16. For example, this container treatment device can be configured for pasteurizing containers.

The control device 46 can have a communication connection to the detection device 20, 21, to the drive 28, to the at least one further detection device 38, 40, to the first container treatment device 42, and/or to the second container treatment device 44. The communication connection can for example be wireless or wired.

For example, the control device 46 can receive the detected occupancy level from the detection device 20, 21, send operating commands to the drive 28, receive the detected container back-up from the at least one further detection device 38, 40, and/or receive the operating state from the first and/or second container treatment device 42, 44.

The control device 46 is configured to operate the drive 28 in order to move the guide element 24 to a desired position depending on the occupancy level detected by the detection device 20, 21.

Preferably, the control device 46 can operate the drive 28 in order to move the guide element 24 to a desired position for selectively even or uneven division of the container mass flow B to the first container mass flow outlet 14 and the second container mass flow outlet 16.

For example, the control device 46 can operate the distribution device 22 in an equal operating mode. In the equal operating mode, the control device 46 can operate the drive 28 depending on the detected occupancy level in order to move the guide element 24 to a desired position for evenly dividing (50:50) the container mass flow B to the first container mass flow outlet 14 and the second container mass flow outlet 16. The higher the detected occupancy level, the less the guide element 24 can be pivoted out and/or extended by the drive 28 in order to achieve an even distribution.

Alternatively or additionally, the control device 46 can operate the distribution device 22 in an unequal operating mode. In the unequal operating mode, the control device 46 can operate the drive 28 depending on the detected occupancy level in order to move the guide element 24 to a desired position for the (predefined) uneven division (e.g. 100:0; 90:10; 80:20; 70:30; 60:40; 40:60; 30:70; 20:80; 10:90; 0:100) of the container mass flow B to the first container mass flow outlet 14 and the second container mass flow outlet 16. The more containers of the container mass flow B are to be distributed to the second container mass outlet 16, the more the guide element 24 can be pivoted out and/or extended by the drive 28.

Alternatively or additionally, the control device 46 can operate the distribution device 22 in a back-up operating mode. If, for example, a container back-up is detected by the first further detection device 38, the control device 46 can operate the drive 28 in order to move the guide element 24 to a desired position for distributing the entire container mass flow B only to the second container mass flow outlet 16, e.g. by pivoting the guide element out and/or extending the guide element to the maximum. On the other hand, if a container back-up is detected, for example, by the second further detection device 40, the control device 46 can operate the drive 28 in order to move the guide element 24 to a desired position for distributing the entire container mass flow B only to the first container mass flow outlet 14, e.g. by pivoting the guide element in and/or retracting the guide element to the maximum.

Alternatively or additionally, the control device 46 can operate the distribution device 22 for example also depending on a (current) operating state (e.g. performance (=containers treated per unit of time) or error message) of the first and/or second container treatment device 42, 44. For example, the distribution of the container flow B to the first and second container mass flow outlets 14, 16 can thus be carried out depending on performance or error case.

For example, the distribution device 22 can be operated by the control device 46 such that a larger proportion of the container mass flow B is distributed to the first container mass flow outlet 14 and thus to the first container treatment device 42 when a current performance of the first container treatment device 42 is higher than a predefined limit value or is higher than a current performance of the second container treatment device 44.

For example, the distribution device 22 can be operated by the control device 46 such that the entire container mass flow B is distributed to the second container mass flow outlet 16 and thus to the second container treatment device 44 when a malfunction of the first container treatment device 42 occurs (e.g. received as an error signal by the control device 46, e.g. sent as an error signal from the first container treatment device 42).

It is also possible, for example, for a further distribution device to be arranged on a longitudinal side of the container mass flow conveyor 12 opposite the distribution device 22 (not shown in the figures). The further distribution device can be configured like the distribution device 22. The further distribution device can, for example, be configured as a mirror image of the distribution device 22. The further distribution device can, for example, be located directly opposite the distribution device 22 or can be arranged offset from the distribution device 22 with respect to a longitudinal axis or conveying direction of the container mass flow conveyor 12.

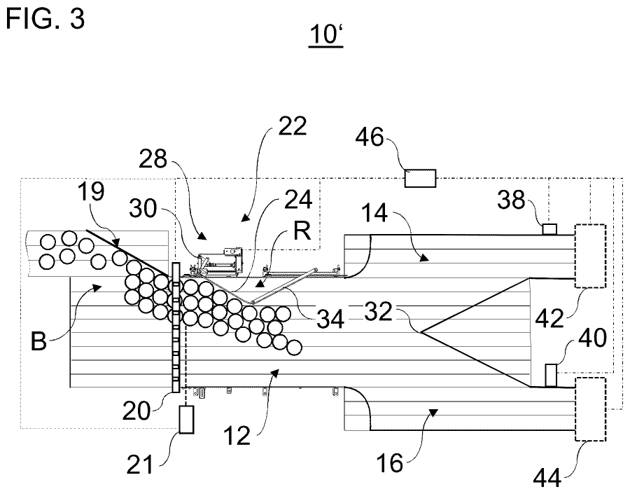

FIG. 3 shows a modified apparatus 10′, in which a lateral transfer 19 is included instead of the curved portion 18 (see FIG. 1).

The lateral transfer 19 can, for example, have a guide element, such as a guide wall or a guide railing, for the container mass flow B. Preferably, the lateral transfer 19 can extend obliquely over a portion of the container mass flow conveyor 12. For example, a longitudinal axis of the lateral transfer 19 can be angled to a conveying direction of the container mass flow conveyor 12 and angled to a width direction of the container mass flow conveyor 12.

Preferably, the lateral transfer 19 can push the container mass flow B from a longitudinal side of the container mass flow conveyor 12 laterally onto a straight portion of the container mass flow conveyor 12.

The lateral transfer 19 can be arranged on the input side with respect to the apparatus 10′. The lateral transfer 19 can be arranged upstream of the distribution device 22.

As shown in FIG. 3, the lateral transfer 19 can be configured and/or operable in such a way that the containers of the container mass flow B are stimulated or acted upon to be applied to a longitudinal side of the container mass flow conveyor 12. For example, the containers of the container mass flow B can be stimulated or acted upon by the lateral transfer 19 in such a way that, in addition to the movement in the conveying direction of the container mass flow conveyor 12, they also move in a direction transverse to the conveying direction or longitudinal axis and abut against one another and against the lateral transfer 19 as well as the respective longitudinal side of the container mass flow conveyor 12.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the container mass flow conveyor, the distribution device, the detection device, and/or the control device of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 apparatus for dividing a container mass flow
12 container mass flow conveyor
14 first container mass flow outlet
16 second container mass flow outlet
18 curved portion
19 lateral transfer
20, 21 detection device
22 distribution device
24 guide element
26 covering
28 drive
30 gearing
32 guide element
34 container back-up protection element
36 covering
38 first further detection device
40 second further detection device
42 container treatment device
44 container treatment device
46 control device
B container mass flow
R (dead) space

What is claimed is:

1. An apparatus for dividing a container mass flow for a container treatment system, wherein the apparatus comprises:
a container mass flow conveyor having a first container mass flow outlet and a second container mass flow outlet arranged next to the first container mass flow outlet;
a distribution device having a movable guide element for dividing the container mass flow to the first container mass flow outlet and the second container mass flow outlet and having a drive which is drivingly connected to the movable guide element in order to move the movable guide element;
a detection device which is configured to detect an occupancy level of the container mass flow conveyor upstream of the distribution device; and
a control device configured to operate the drive in order to move the movable guide element to a desired position depending on the detected occupancy level of the container mass flow to the first container mass flow outlet and the second container mass flow outlet.

2. The apparatus according to claim 1, wherein:
the drive has a self-locking gearing.

3. The apparatus according to claim 1, wherein one of:
the movable guide element is mounted on a longitudinal outer side of the container mass flow conveyor such that said guide element is pivotable about a vertical axis for pivoting over a conveying face of the container mass flow conveyor; and
the movable guide element is mounted on a longitudinal outer side of the container mass flow conveyor for translation at an angle to a conveying direction of the container mass flow conveyor in order to move over a conveying face of the container mass flow conveyor.

4. The apparatus according to claim 1, wherein at least one of:
the movable guide element is pivotable,
the drive is drivingly connected to the movable guide element in order to pivot the movable guide element,
the detection device is one of a contactless detection device and a tactile detection device,
the control device is configured to operate the drive to move the movable guide element to the desired position depending on the detected occupancy level selectively for one of even and uneven division of the container mass flow to the first container mass flow outlet and the second container mass flow outlet,
the drive has a self-locking worm gearing, and
the movable guide element is mounted on a longitudinal outer side of the container mass flow conveyor for translation transversely to a conveying direction of the container mass flow conveyor in order to move over a conveying face of the container mass flow conveyor.

5. The apparatus according to claim 1, wherein at least one of:
the movable guide element is a swivel arm; and
the movable guide element is covered with a wall-shaped covering for guiding containers.

6. The apparatus according to claim 1, wherein:
the detection device is configured to detect the occupancy level as a degree to which the container mass flow conveyor is occupied by containers transversely to its conveying direction.

7. The apparatus according to claim 1, wherein the detection device is configured to detect the occupancy level as a degree to which the container mass flow conveyor is occupied by containers transversely to its conveying direction at least one of:
as a number of one of transport tracks and transport elements of the container mass flow conveyor occupied by one of containers of the container mass flow and a value derived therefrom;
by detecting a container-free transport width of one of the container mass flow conveyor and a value derived therefrom; and
starting from a longitudinal side of the container mass flow conveyor, preferably one of the longitudinal side on which the movable guide element is arranged, and the longitudinal side which is arranged opposite the movable guide element.

8. The apparatus according to claim 1, wherein:
the detection device is configured to detect the occupancy level in a curved portion of the container mass flow conveyor one of directly downstream of a curved portion of the container mass flow conveyor, at a lateral transfer of the container mass flow conveyor, and directly downstream of a lateral transfer of the container mass flow conveyor, and
one of the curved portion and the lateral transfer is at least one of configured and operable to stimulate the containers of the container mass flow to be applied to a longitudinal side of the container mass flow conveyor.

9. The apparatus according to claim 1, wherein at least one of:
the detection device has one of a sensor bridge and a sensor bar which is arranged upstream of the distribution device and above the container mass flow conveyor;
the detection device has a distance sensor which is arranged upstream of the distribution device and laterally next to the container mass flow conveyor; and
the detection device has a camera for detecting the occupancy level.

10. The apparatus according to claim 9, wherein at least one of:
the one of the sensor bridge and the sensor bar has a plurality of spaced-apart sensors,
the detection device has the one of the sensor bridge and the sensor bar which is arranged upstream of the distribution device and above the container mass flow conveyor transversely to a conveying direction of the container mass flow conveyor, and
the distance sensor is arranged upstream of the distribution device and laterally next to the container mass flow conveyor at least one of aligned at a container conveying height of the container mass flow conveyor and transversely to a conveying direction of the container mass flow conveyor.

11. The apparatus according to claim 1, wherein:
the distribution device further comprises a wedge-shaped guide element which is arranged at a common upstream end of the first container mass flow outlet and of the second container mass flow outlet between the first container mass flow outlet and the second container mass flow outlet.

12. The apparatus according to claim 1, further comprising:
at least one further detection device which is configured to detect a container back-up at least one of in or downstream of the first container mass flow outlet and in or downstream of the second container mass flow outlet,
wherein the control device is further configured to operate the drive in order to move the movable guide element to a desired position depending on the detected container back-up.

13. The apparatus according to claim 1, further comprising:
a first container treatment device arranged downstream only from the first container mass flow outlet; and
a second container treatment device arranged downstream only from the second container mass flow outlet,
wherein the control device is further configured to operate the drive in order to move the movable guide element to a desired position depending on at least one of an operating state of the first container treatment device and an operating state of the second container treatment device.

14. The apparatus according to claim 1, wherein:
the distribution device further comprises a container back-up protection element which is connected to the movable guide element for movement with the movable guide element in order to shield a space between a longitudinal outer side of the container mass flow conveyor and an inner side of the movable guide element facing the longitudinal outer side.

15. The apparatus according to claim 14, wherein at least one of the following is fulfilled:
the container back-up protection element is connected to a front end of the movable guide element;
the container back-up protection element is mounted on the longitudinal outer side so as to be at least one of pivotable about a vertical axis and translatable in parallel with the longitudinal outer side;
the container back-up protection element is covered with a wall-shaped covering for guiding containers; and
the container back-up protection element is a swivel arm.

16. The apparatus according to claim 14, wherein at least one of:
the container back-up protection element is connected to a front end of the movable guide element in an articulated manner, and
the container back-up protection element is a translatable swivel arm.

17. A method for dividing a container mass flow, comprising:
by a detection device, detecting, upstream of a distribution device, an occupancy level of a container mass flow conveyor conveying a container mass flow; and
by a control device, operating a drive in order to move a movable guide element of the distribution device to a desired position depending on the detected occupancy level so as to divide the container mass flow to a first container mass flow outlet and a second container mass flow outlet of the container mass flow conveyor, selectively for one of even and uneven division of the container mass flow to the first container mass flow outlet and the second container mass flow outlet.

18. The method according to claim 17, wherein at least one of:
the detection device is one of a contactless detection device and a tactile detection device,
the operating a drive in order to move a movable guide element is in order to pivot a guide element,
the guide element is pivotable, and
the method is by an apparatus including:
the container mass flow conveyor having a first container mass flow outlet and a second container mass flow outlet arranged next to the first container mass flow outlet;
a distribution device having a movable guide element for dividing the container mass flow to the first container mass flow outlet and the second container mass flow outlet and having the drive which is drivingly connected to the movable guide element in order to move the movable guide element;
the detection device which is configured to detect the occupancy level of the container mass flow conveyor upstream of the distribution device; and
the control device.

19. The method according to claim 17, wherein at least one of:
the method further comprises, by at least one further detection device, detecting a container back-up at least one of in or downstream of the first container mass flow outlet and in or downstream of the second container mass flow outlet, wherein the operating of the drive by the control device in order to move the movable guide element to a desired position is also carried out depending on the detected container back-up; and
wherein the operating of the drive by the control device in order to move the movable guide element to a desired position is also carried out depending on an operating state of a first container treatment device which is arranged downstream only from the first container mass flow outlet and depending on an operating state of a second container treatment device which is arranged downstream only from the second container mass flow outlet.

20. The method according to claim 17, further comprising:
by a container back-up protection element of the distribution device, preventing a back-up of containers into a space shielded by the container back-up protection element and located between a longitudinal outer side of the container mass flow conveyor and an inner side of the movable guide element facing the longitudinal outer side, wherein the container back-up protection element moves together with the movable guide element.
